(19) United States
(12) Patent Application Publication
(10) Pub. No.: US 2025/0390006 A1
(43) Pub. Date: Dec. 25, 2025

(54) Kamera

(71) Applicant: Proton Camera Innovations GbmH, Garbsen (DE)

(72) Inventor: Marko Höpken, Garbsen (DE)

(21) Appl. No.: 19/243,584

(22) Filed: Jun. 19, 2025

(30) Foreign Application Priority Data
Jun. 21, 2024 (DE) 10 2024 117 597.4

(51) Int. Cl. G03B 17/14

(52) U.S. Cl. CPC G03B 17/14

(57) ABSTRACT

The invention relates to a camera (1) with a camera housing (2) which has a lens receptacle with a tube fitting (3) and an internal thread (4) on the tube fitting (3). The tube fitting (3) comprises a first circumferential groove (5a) running around the inner circumference of the tube fitting (3), with an elastic O ring (7a) in the circumferential groove (5a). The tube fitting (3) has, on the inner circumference of the tube fitting (3), at least two circumferential grooves (5b) which are spaced apart from the first circumferential groove (5a) on a common optical axis (OA) in the direction of extent of the tube fitting (3), and comprises an elastic O ring (7b) in the second circumferential groove (5b).

The invention relates to a camera with a camera housing which has a lens receptacle with a tube fitting and an internal thread on the tube fitting, the tube fitting comprising a first circumferential groove running around the inner circumference of the tube fitting, with an elastic O ring in the circumferential groove.

Conventional cameras have either a lens which is fixedly installed in the camera housing or a lens adapter on which a separate lens can be exchangeably mounted. Lens comprise an arrangement of optical lens elements used to determine the image recording characteristics of the camera. A lens creates a real optical reproduction of an object of which an image is to be recorded, by collecting the light rays. For instance, images can be recorded at various image angles for example by wide-angle, standard, telephoto, zoom or fisheye lenses. Filter disks on or in lenses also make it possible to filter certain color spectra, either in the form of a band-pass filter or a band-stop filter. The focal length of the lens can be used to set the size of the image reproduction and the focus. The image characteristics can be varied as and when required with a settable lens.

Conventional lens receptacles can be designed in the form of a bayonet closure or threaded connection. The threaded connections are produced as fine threads that allow the focus to be set precisely. The focus is obtained by screwing the lens in or out, there being no fixed “back focus”. The focus depends on the lens and the distance from the object and is dependent on the screw-in depth of the lens in the lens receptacle. The lens is not screwed in as far as an end stop when it is being variably set and must therefore be secured in order to prevent the focus from shifting, the lens from falling out during operation and the lens element from tilting. The tilting of the lens element leads to a distortion of the image and results in a non-centered image.

To secure the lens, lock nuts or lock rings on the lens are known; they are very small and thus unpleasant to set.

It is also possible to exert a spring force on the lens element from the lens side, e.g. by means of an elastic spring. However, in this case a special spring length is required for each lens and it is not possible to ensure that the lens is stably secured.

The lens can also be secured from the side by a clamping screw. This can, however, lead to damage to the lens thread and the focus can shift during the screwing-down operation.

The fixing in place can also be effected with undersized flexible polymer receptacles which have the effect of clamping by way of a fit. Resins that prevent shifting can be used for this. The polymer receptacles are, however, problematic in the event of high differences in temperature and dirt.

Also conceivable is adhesively bonding the lens, although this disadvantageously no longer allows further setting of the focus.

The fixing in place can also be effected by a rubber ring in the thread, which secures the lens owing to its elasticity. Disadvantageously, the lens can tilt.

To improve a camera of the type in question equipped with an O ring, DE 29 43 003 A1 proposes a watertight seal arrangement for cameras, in the case of which a step is formed in the outer end of the opening and a soft component in the form of a short sleeve is fixedly connected to the step and the inner circumferential face and the upper end face thereof are held in a close fit against a rotatable shaft arrangement.

U.S. Pat. No. 5,177,515 A describes a watertight camera in which an external thread of a watertight outer cylinder of a lens is screwed in the internal thread of a lens mount, a first O ring being located on the outer circumference of the outer cylinder and upstream of the external thread in the screwing direction. The camera further has an internal fastening flange connected leaktightly to the camera housing by a second O ring.

An object of the present invention is to provide an improved camera.

The object is achieved by the camera having the features of claim 1. Advantageous embodiments are described in the dependent claims.

It is proposed that the tube fitting has, on the inner circumference of the tube fitting, a second circumferential groove which runs around the circumference and is spaced apart from the first circumferential groove in the direction of extent of the tube fitting, and comprises an elastic O ring in the second circumferential groove.

In this way, the lens is fixed in place in the turn of the thread by the elasticity of the O rings located in line on the optical axis and at the same time is secured against tilting by the at least two O rings located one behind the other. Moreover, redundancy of sealing is provided and the risk of moisture getting into the interior space of the camera housing is thereby further reduced.

The camera may preferably be a digital camera comprising an image-recording sensor in the camera housing and image-recording electronics connected to the image-recording sensor.

The internal thread may be divided into multiple segments in the direction of extent of the tube fitting.

The transition between two mutually adjoining segments may contain a circumferential groove. In this way, the elastic O ring located in the circumferential groove continues the segmented thread, the external thread of the lens being form-fittingly and frictionally engagingly screwed from one threaded segment through the elastic O ring to the further threaded segment adjoining the O ring. This ensures a leaktight screwed fastening, with zero mechanical clearance, of the lens to the camera housing in the coaxial alignment of the threaded segments without the risk of tilting.

The circumferential grooves in the tube fitting of the lens receptacle with the O rings introduced therein thus form the separating regions between the successive thread-turn segments.

The internal thread can thus adjoin the first circumferential groove on either side and adjoin the second circumferential groove on either side.

This makes it possible to screw a suitable lens, not specifically designed for sealing, in centered fashion through the internal thread into the tube fitting of the camera, i.e. the lens mount, and thus reliably seal the lens leaktightly using the O rings. The O rings are not damaged on screwing in owing to the arrangement of the circumferential grooves between the internal thread profiles. The seal in the internal thread allows the use of any suitable screw-type lens element and has the effect of reducing costs such that conventional lenses can be used.

The thread may be for example an M6, M7, M8, M9, M10, M12, M13, M14 or M17 fine thread.

The inner circumference of the tube fitting may have more than two circumferential grooves which run around the circumference and are spaced apart from one another in the direction of extent of the tube fitting, the circumferential grooves segmenting an internal thread, which is continuous in the direction of extent, of the tube fitting. This further improves the coaxial securing of the lens on the longitudinal axis of the tube fitting by means of its internal thread, by the lens being elastically fixed in place by frictional engagement on two or more O rings concentrically spaced apart, one behind the other, in the respective circumferential grooves.

The invention will be explained in more detail below by way of example on the basis of an exemplary embodiment. In the drawing:

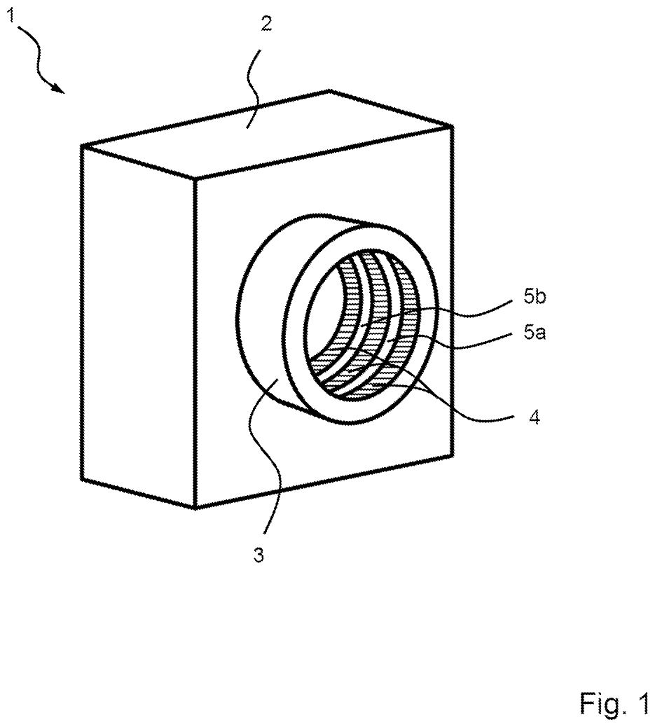

FIG. 1—shows a perspective sketch of a camera with a camera housing and with a lens receptacle in the form of a tube fitting;

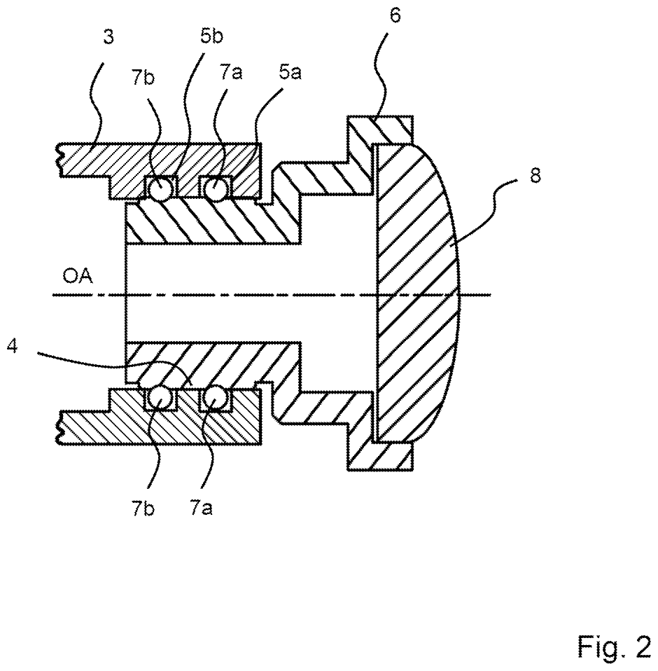

FIG. 2—shows a sectional side view of the lens receptacle in the form of a tube fitting with a lens screwed in and secured by multiple O rings;

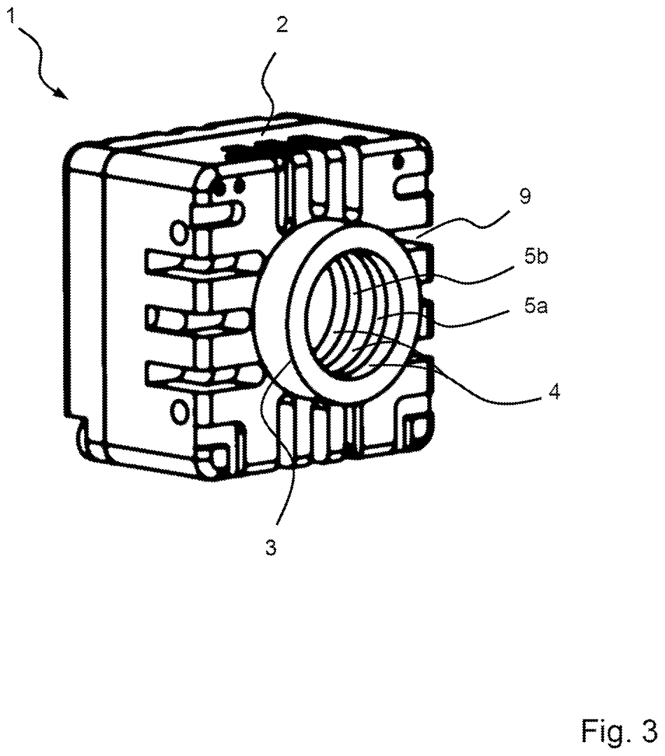

FIG. 3—shows a perspective view of a miniature camera with a tubular lens receptacle.

FIG. 1 shows a perspective sketch of a camera 1 with a camera housing 2 and with a lens receptacle formed by a tube fitting 3. The tube fitting 3 is connected to the camera housing 2. It may for example be formed integrally with the camera housing or be fastened to the camera housing 2 in the form of a separate part.

The cylindrical inner wall of the tube fitting 3 has an internal thread 4 and two circumferential grooves 5a, 5b, into each of which an elastic O ring, for example made of a rubber material, can be placed.

The internal thread 4, which is continuous with its thread turn, is interrupted by the circumferential grooves 5a, 5b and divided into three segments in this way.

FIG. 2 shows a sectional side view of the tube fitting 3 of the lens receptacle with a lens 6 which has been screwed into an internal thread 4 of the tube fitting 3. It shows that, in the direction of extent of the tube fitting 3, which is located concentrically on an optical axis OA, i.e. forms the latter, there are two circumferential grooves 5a, 5b in the inner wall of the tube fitting 3. They are designed such that they run around over the inner circumference of the cylindrical tube fitting 3. A elastic O ring 7a, 7b is placed in each of the circumferential grooves 5a, 5b. The O rings 7a, 7b may for example be made of a rubber material. They serve to secure the lens 6, which has been screwed into the internal thread 4, by way of the frictionally engaging fixing with the elastic O rings 7a, 7b. Since the circumferential grooves 5a, 5b and thus the O rings 7a, 7b are spaced apart on the optical axis OA, the lens 6 is centered on the optical axis OA and secured against tilting. Furthermore, the lens 6 is redundantly secured, on two mutually spaced apart retaining faces, against rotating on the internal thread 4 and thus against shifting in the direction of extent of the optical axis OA. It is still possible to screw in the lens 6 and set the focus, which depends on the screw-in depth. All that is necessary is to overcome the frictional force exerted by the O rings 7a, 7b.

In the exemplary embodiment illustrated, the lens 6 has a lens element 8. A lens element system with multiple lens elements 8 is, however, also conceivable. The lens 6 may, however, also bear other optical elements, such as filter disks and the like. They may be present as an alternative or in addition to the lens element 8.

A camera 1 is therefore conceivable which has a lens element 8 fixedly installed upstream of the lens receptacle as viewed in the direction of an image sensor, the lens 6 in that case being designed to bear additional optical elements selected from the following group: lens elements 8, filters, gratings, aperture plates, condenser lens elements, diffractive optical elements and the like.

FIG. 3 shows a perspective view of a miniature camera 1 with a lens receptacle formed by a tube fitting 3. It shows that the internal thread 4, which is continuous with its thread turns, is divided into three thread segments by two mutually spaced apart circumferential grooves 5a, 5b which run around the circumference and are made in the inner wall of the tube fitting 3.

The camera housing 2 can have cooling ribs 9 on its outer face, in order to discharge the heat arising during operation of the camera electronics. This also makes it possible to reduce the temperature sensitivity of the fastening of the lens 6 to the lens receptacle.

### LIST OF REFERENCE SIGNS

1 Camera
2 Camera housing
3 Tube fitting

04 Internal thread
5a, 5b Circumferential grooves
6 Lens
7a, 7b O rings
8 Lens element
9 Cooling ribs
OA Optical axis

1. A camera, comprising:
a camera housing;
a lens receptacle in the camera housing, wherein the lens receptacle has a tube fitting comprising
an internal thread on the tube fitting,
a first circumferential groove running around an inner circumference of the tube fitting,
a first elastic O ring positioned or positionable in the first circumferential groove,
wherein on the inner circumference of the tube fitting there is a second circumferential groove which runs around the inner circumference, wherein the second circumferential groove is spaced apart from the first circumferential groove on a common optical axis in a direction of extent of the tube fitting, and
a second elastic O ring positioned or positionable (7b) in the second circumferential groove.

2. The camera according to claim 1, wherein the internal thread is divided into multiple segments on the optical axis in the direction of extent of the tube fitting.

3. The camera according to claim 2, wherein a transition between two mutually adjoining segments of the multiple segments contains a respective one of the first circumferential groove or the second circumferential groove.

4. The camera according to claim 1 wherein the internal thread is an M6, M7, M8, M9, M10, M12, M13, M14 or M17 fine thread.

5. The camera according to claim 1 wherein the inner circumference of the tube fitting has a plurality of circumferential grooves inclusive of the first circumferential groove and the second circumferential groove, wherein each of the plurality of circumferential grooves run around the inner circumference and wherein said circumferential grooves are spaced apart from one another on the optical axis in the direction of extent of the tube fitting, wherein the plurality of circumferential grooves segment the internal thread, wherein the internal thread is continuous in the direction of extent of the tube fitting.

6. The camera according to claim 1 wherein the internal thread adjoins the first circumferential groove on either side and adjoins the second circumferential groove on either side.
